(19) United States
(12) Patent Application Publication
(10) Pub. No.: US 2020/0207279 A1
(43) Pub. Date: Jul. 2, 2020

(54) STRUCTURE MOUNTING DEVICE

(71) Applicant: Scosche Industries, Inc., Oxnard, CA (US)

(72) Inventor: Michael Kulick, Simi Valley, CA (US)

(21) Appl. No.: 16/728,219

(22) Filed: Dec. 27, 2019

Related U.S. Application Data
(60) Provisional application No. 62/786,237, filed on Dec. 28, 2018.

(51) Int. Cl. B60R 11/00; F16B 2/10; F16M 13/02; F16B 2/00

(52) U.S. Cl. CPC B60R 11/00; F16B 2/10; F16M 13/022; B60R 2011/007; B60R 2011/0059; B60R 2011/0089; F16B 2/005

(57) ABSTRACT

A mounting device includes a clamp base with a jaw coupling platform with a first pivot bearing and a second pivot bearing. The clamp base defines a mounting platform, an arcuate jaw, and a clevis with a pair of clevis prongs each with a bushing hole. A clamp brace defines a clevis tang engagement slot and an arcuate jaw, and includes an extension arm with a pivot pin engageable with either the first pivot bearing or the second pivot bearing. A clevis pin has a central cross bore, and is received within the bushing holes of the pair of clevis prongs. A clevis tang bolt is engageable with the clevis pin, and is received within the clevis pin engagement slot. A pair of arcuate inserts are each engaged to a respective one of the arcuate jaws of the clamp base and the clamp brace.

### CROSS-REFERENCE TO RELATED APPLICATIONS

The application relates to and claims the benefit under 35 U.S.C. § 119(e) to U.S. Provisional Patent Application No. 62/786,237 filed Dec. 28, 2018 and entitled “STRUCTURE MOUNTING DEVICE,” the entire contents of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to an apparatus for securing articles, and more particularly, to a structure mounting device.

### 2. Related Art

While operating a motor vehicle, ready access to a variety of accessories beyond standard installed components and controls therefor may be needed or desired. For example, navigation, audio playback, and/or telephone communication functions of a smartphone may need to be utilized while driving an automobile, and a hands-free operation may be best facilitated by mounting the smartphone to the dashboard, an air conditioning vent, or other surface proximal to the driver. There are numerous smartphone mount devices known in the art, including those that clamp the smartphone in a cradle, with the cradle, in turn, being attached to the dashboard or the windshield via a suction cup mount, an adhesive mount, or the like. Instead of a cradle, there may be a magnetic head that magnetically couples to smartphone to the head, while using the same base mounts.

Within the enclosed space of an interior of an automobile or the like that is travelling on smooth, established roadways, the durability and extent of securement of the accessory mounts are not as critical compared to vehicles that are operated under harsher conditions. There are greater demands on accessory mounts for vehicles in which the operator, and hence accessories that are immediately accessible to the operator, that are exposed to greater wind, shock, and vibration forces such as all-terrain vehicles, motorcycles, and the like. Furthermore, such vehicles may have fewer locations in its interior to which an accessory mount can be attached. For example, one of the few locations on a motorcycle in which additional components can be mounted for view/access/use during operation is the handlebar. All-terrain vehicles (ATVs) and utility vehicles (UTVs), and various off-highway vehicles are likewise limited with respect to the locations on which an accessory mount can be attached, though such vehicles may have roll cages, sway bar and other tubular structures that surround the driver and passengers.

The base mounts that secure smartphones and other electronic devices to such tubular structures of vehicles are known in the art and are typically of the clamp type comprised of a pair of jaws that are compressed against the structure. The base mount, in turn, may incorporate or otherwise attach to a device mount such as the aforementioned cradle or magnetic head.

The outer diameter as well as the profile of such tubular structures may vary in accordance with the application and specific role in which it is utilized relative to the overall vehicle configuration. For instance, a roll cage is understood to be an integral part of the vehicle frame, and so the tubular structure thereof will have a larger outer diameter, while a grab handle or other decorative tubular structure may have a smaller outer diameter. Some tubular structures may have a circular profile, while others, such as roof racks, may have a more oval or flat profile.

Because of the varying sizes and profiles of the tubular structures to which there is a desire to mount different devices, there is a need in the art for a base mount that can be adjusted to such sizes and profiles. Additionally, there is a need in the art for a structure mounting device with adjustability along multiple parameters to accommodate varying structure configurations.

### BRIEF SUMMARY

The embodiments of the present disclosure are directed to a mounting device. In one embodiment, there may be a clamp base with a jaw coupling platform defining a first pivot bearing and a second pivot bearing. The clamp base may also define a clevis with a pair of clevis prongs each defining a bushing hole, as well as a mounting platform, and an arcuate jaw. There may also be a clamp brace that includes an extension arm with a pivot pin engageable with either one of the first pivot bearing and the second pivot bearing of the clamp base. The clamp brace may define a clevis tang engagement slot and an arcuate jaw. The mounting device may further include a clevis pin that defines a central cross bore. The clevis pin may be received within the bushing holes of the pair of clevis prongs. There may also be a clevis tang bolt that is engageable with the clevis pin. The clevis tang bolt may also be received within the clevis pin engagement slot of the clamp brace. The mounting device may also include a pair of arcuate inserts, each of which may be engaged to a respective one of the arcuate jaws of the clamp base and the clamp brace.

Another embodiment of the present disclosure is a clamp mount. The clamp mount may include a first jaw defined by a first side with a first pivot hole and a second pivot hole offset from the first pivot hole. The first jaw may also define an opposed second side that defines a link hole. There may also be a second jaw that is defined by a first side with an arm including a pivot pin rotatably engageable with a selected one of the first hole and the second pivot hole of the first jaw. The second jaw may also be defined by an opposed second side with a link slot. The clamp mount may include a link pin that is engaged to the link hole, along with a connecting bolt that extends through the link slot of the second side of the second jaw. The connecting bolt may also be engaged to the second jaw, and connected to the link pin. There may also be elastomeric jaw inserts that are fixed to the first jaw and the second jaw.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a front perspective view of a first embodiment of the mounting device with magnetic device mount;

FIG. 1B is a rear perspective view of the first embodiment of the mounting device;

FIG. 2 is an exploded perspective view of the mounting device;

FIG. 3 is a partially exploded front view of the mounting device;

FIG. 4A is a partial front view of the mounting device illustrating a clamp base and a clamp brace separated therefrom prior to engagement;

FIG. 4B is a partial front view of the mounting device with the clamp brace engaged to the clamp base;

FIG. 4C is a partial front view of the mounting device with the clamp brace engaged to the clamp base, and a clevis tang bolt connecting the clamp brace to the clamp base in a first contracted position;

FIG. 4D is a partial front view of the mounting device with the clamp brace engaged to the clamp base, and the clevis tang bolt connecting the clamp brace to the clamp base in a second extended position; and

FIG. 5 is a front perspective view of a second embodiment of the mounting device with a retention strap.

### DETAILED DESCRIPTION

The detailed description set forth below in connection with the appended drawings is intended as a description of the presently preferred embodiment of a structure mounting device, and is not intended to represent the only form in which it can be developed or utilized. The description sets forth the structure and functions of the mounting device in connection with the illustrated embodiments. It is to be understood, however, that the same or equivalent functions may be accomplished by different embodiments that are also intended to be encompassed within the scope of the present disclosure. It is further understood that the use of relational terms such as first, second, left, right, top, bottom, distal, proximal, and the like are used solely to distinguish one from another entity without necessarily requiring or implying any actual such relationship or order between such entities.

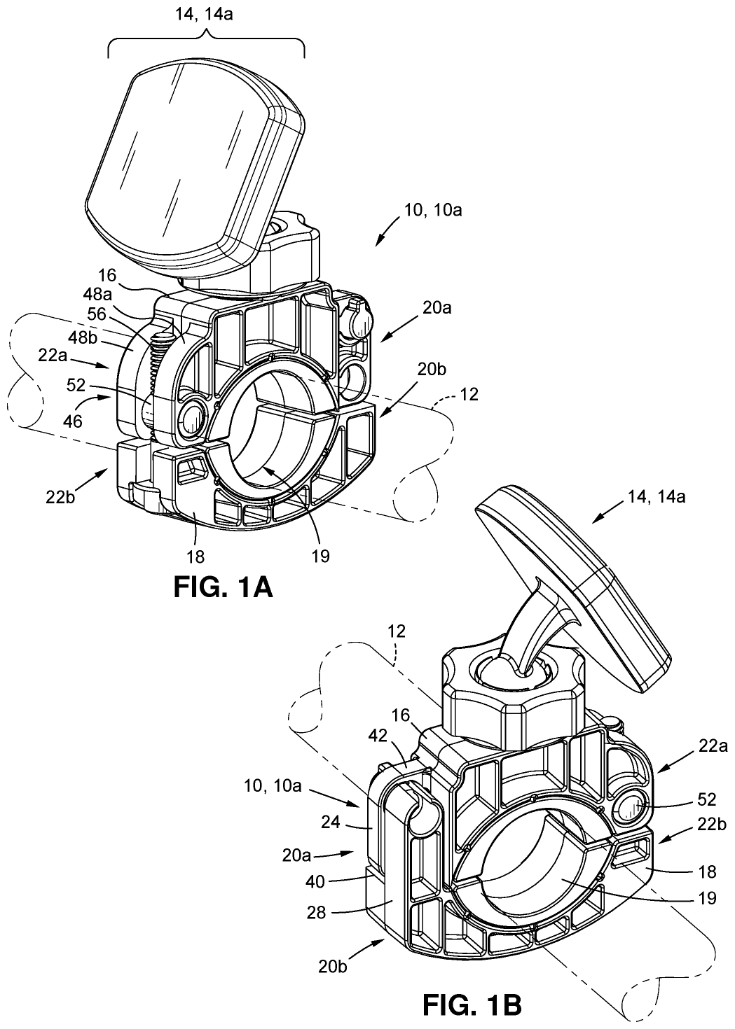

Referring now to FIGS. 1A and 1B, the various embodiments of the present disclosure are directed to a structure mounting device 10 that may be secured to a structure 12. The mounting device 10 supports a secondary mount 14, which in the illustrated first embodiment 10a is a magnetic device mount to which a user device may be releasably attached. Because the secondary mount 14 is typically utilized for this function, it may also be referred to as a user device mount. Additional details of the magnetic device mount will be considered more fully below, along with other possible implementations of the secondary mount 14. As shown, the structure 12 may have a tubular shape, and the various embodiments of the mounting device 10 are configured to accommodate such configuration. The structure 12 may be that of a vehicle such as a roll cage or frame, but this is by way of example only and not of limitation. The mounting device 10 may be adapted for mounting to other structures, and such structures need not be limited to those having a tubular or otherwise generally cylindrical shape.

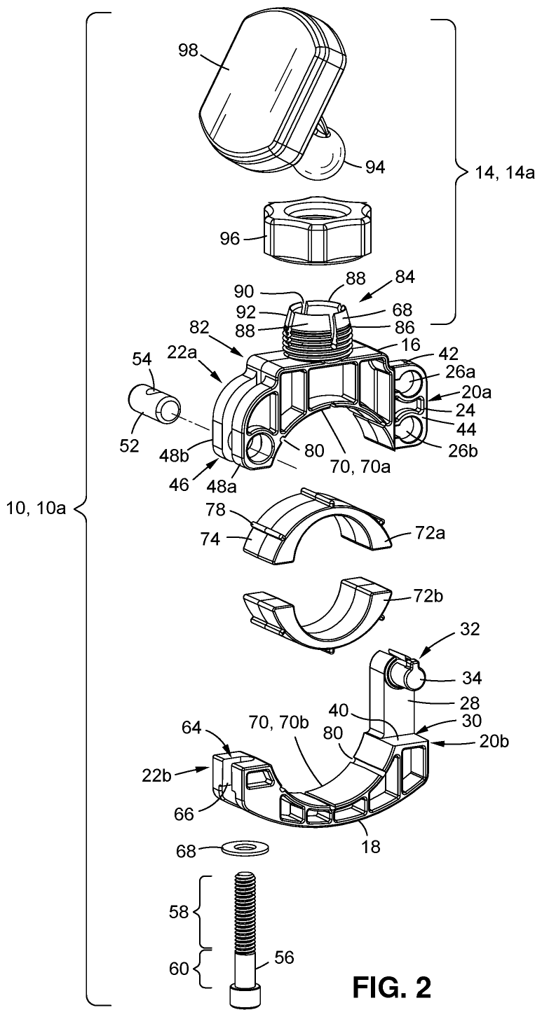

With additional reference to FIG. 2, the mounting device 10 is generally comprised of a clamp base 16 that is engageable with a clamp brace 18 to sandwich or otherwise compressively mount the entire assembly of the mounting device 10 to the aforementioned structure 12. In accordance with various embodiments of the present disclosure, a clamping space 19 between the clamp base 16 and the clamp brace 18 may be adjustable along multiple parameters. As illustrated, the clamp base 16 and the clamp brace 18 may be coupled at two opposing sides thereof, and various embodiments of the present disclosure contemplate different selective adjustability modalities for both such coupling points.

In further detail, the body of the clamp base 16 may be defined by a right side 20a and an opposed left side 22a, while the body of the clamp brace 18 may likewise be defined by a right side 20b and an opposed left side 22b. Again, FIGS. 1A and 1B illustrate the right side 20a of the clamp base 16 being coupled, linked, or otherwise engaged to the right side 20b of the clamp brace 18, and the left side 22a of the clamp base 16 is coupled, linked, or otherwise engaged to the left side 22b of the clamp brace 18. As described herein, the right sides 20 and the left sides 22 are understood to refer to side portions of the clamp base 16 and the clamp brace 18, with reference thereto being based upon an orientation of a front face of the mounting device 10 presented in FIG. 1A. In the opposing rear face of the mounting device 10 presented in FIG. 1B, the right sides 20 of the clamp base 16 and the clamp brace 18 appear toward the left, while the left sides 22 of the clamp base 16 and the clamp brace 18 appear toward the right. For the sake of consistency, however, the relative directions are not swapped.

The right side 22a of the clamp base 16 includes a jaw coupling platform 24 that defines a first pivot bearing 26a and a second pivot bearing 26b. These features may be alternatively referred to as first and second pivot holes. As mentioned above, the clamp base 16 is coupled to the clamp brace 18 at the right sides 20 thereof. The clamp brace 18 includes an extension arm 28 extending from the body of the clamp brace 18, and the extension arm 28 is defined by a linking end 30 that is connected to or otherwise integral with the body of the clamp brace 18. Opposite the linking end 30 is a distal end 32 that includes a pivot pin 34 that is engageable with either one of the first pivot bearing 26a or the second pivot bearing 26b.

The pivot pin 34 is sized and configured to match and fit within the first pivot bearing 26a and the second pivot bearing 26b. Furthermore, the pivot pin 34 is keyed, that is, there is a key tab 36 that radially extends from the pivot pin 34. The pivot bearings 26 define a corresponding keyway slot 38 with which the key tab 36 is aligned in order for the pivot pin 34 to be inserted into or withdrawn from the pivot bearings 26. Like the pivot pin 34, the key tab 36 thereof is also sized and configured to fit within the keyway slots 38 of the pivot bearings 26.

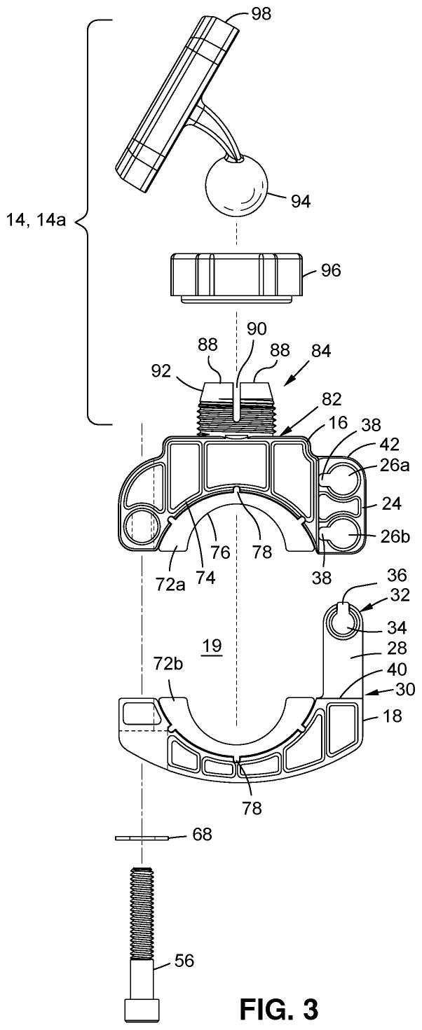

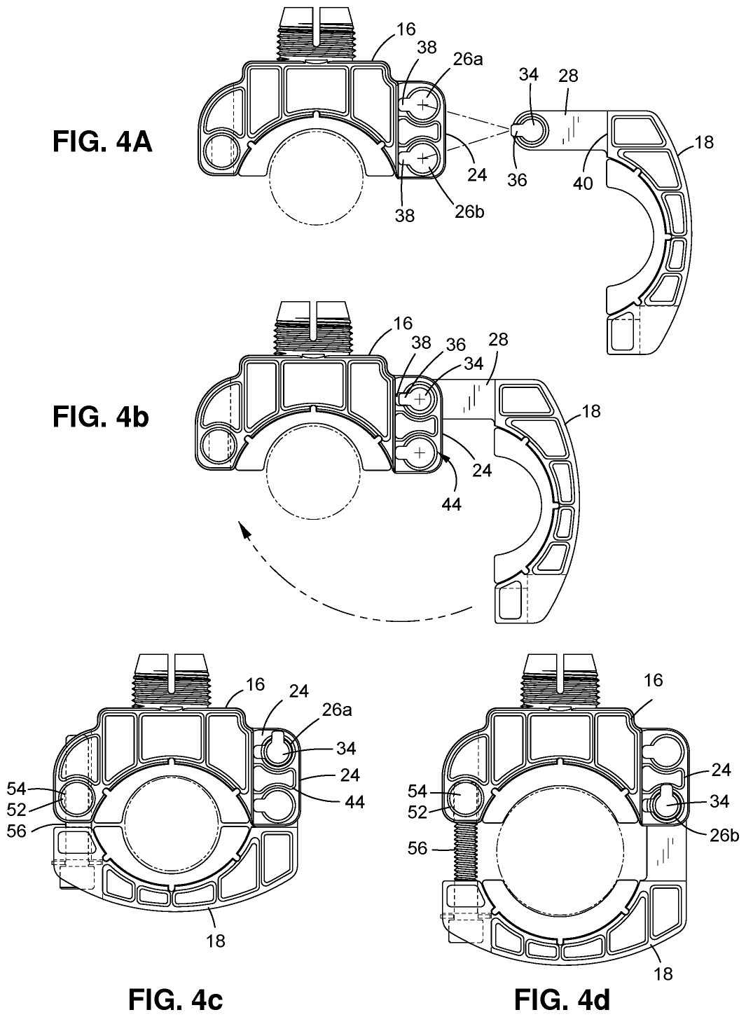

Referring additionally to FIGS. 4A and 4B, with the clamp base 16 separated from the clamp brace 18, the clamp brace 18 is rotated approximately 90 degrees counterclockwise relative to position illustrated in FIG. 3 where the clamp brace 18 is coupled to the clamp base 16. By aligning the key tab 36 with the keyway slot 38 and aligning the barrel of the pivot pin 34 with the hole of the pivot bearing 26, the pivot pin 34 may be inserted into the pivot bearing 26 to couple the clamp brace 18 to the clamp base 16.

In accordance with the reference orientations discussed above, the first pivot bearing 26a is vertically offset from the second pivot bearing 26b. Inserting the pivot pin 34 to the first pivot bearing 26a as shown in FIGS. 4B and 4C sets a first predetermined distance between the clamp base 16 and the clamp brace 18 at the right side 20. Inserting the pivot pin 34 to the second pivot bearing 26b as shown in FIG. 4D similarly sets a second predetermined distance between the clamp base 16 and the clamp brace 18 at the right side 20. The first predetermined distance is understood to be less than the second predetermined distance, specifically by the spacing between the center of the first pivot bearing 26a and the center of the second pivot bearing 26b. The selection of the first pivot bearing 26a or the second pivot bearing 26b is understood to constitute a coarse adjustment modality, in which the mounting device 10 can be secured to a larger structure 12 by utilizing the second pivot bearing 26b and accommodate securely a smaller structure 12 by utilizing the first pivot bearing 26a to attach the clamp brace 18 to the clamp base 16.

The illustrated embodiment of the mounting device 10 contemplates a length dimension of the extension arm 28 being substantially the same as the length dimension of the jaw coupling platform 24. When in a coupled position as shown in FIG. 4C, the extension arm 28 does not extend past an upper extent 42 of the jaw coupling platform 24, and is not hindered from free rotation by the body of the clamp base 16 in the counter-clockwise rotated position shown in FIG. 4B.

The extension arm 28 of the clamp brace 18 and the jaw coupling platform 24 of the clamp base 16 define thicknesses that are approximately half that of the respective bodies of the clamp brace 18 and the clamp base 16. As best illustrated in FIG. 1B, the extension arm 28 is in a partially interlocking relationship with the jaw coupling platform 24 when the clamp base 16 is coupled with the clamp brace 18. That is, the jaw coupling platform 24 extends only so far as an intermediate shelf 40 of the clamp brace 18, and as mentioned above, the extension arm 28 extends only so far as the upper extent 42 of the jaw coupling platform 24. Thus, in a limited profile of the right sides 20 of the clamp base 16 and the clamp brace 18, extends both the jaw coupling platform 24 and the extension arm 28 that is freely rotatable about the centers of the first pivot bearing 26a and the second pivot bearing 26b.

The pivot pin 34 extends perpendicularly relative to the axis of the extension arm 28 and is understood to have a length that is slightly longer than the thickness of the jaw coupling platform 24. In order for the pivot pin 34, and hence the extension arm 28 to which it is attached to be rotatable, the key tab 36 clears the front face 44 of the jaw coupling platform 24. Once the pivot pin 34 is rotated within the selected pivot bearing 26 and the key tab 36 is in a position offset from the keyway slot 38 as best illustrated in FIGS. 4C and 4D, the key tab 36 effectively locks the pivot pin 34 in place while permitting rotation but preventing the pivot pin 34 from being withdrawn from the pivot bearing 26 and thus the clamp brace 18 from being decoupled from the clamp base 16.

The selective adjustability modality that couples the left sides 22 of the clamp base 16 and the clamp brace 18 together will now be considered. As shown in FIG. 1 and FIG. 2, the clamp base 16 includes a clevis 46 with a pair of clevis prongs 48a and 48b. The end of the first clevis prong 48a defines a first bushing hole 50a, and the end of the second clevis prong 48b defines a second bushing hole 50b. The size and shape of the clevis prongs 48a, 48b are understood to be identical, and further, the first bushing hole 50a and the second bushing hole 50b are aligned and coaxial. Inserted through the first bushing hole 50a and the second bushing hole 50b is a clevis pin 52. In this regard, the diameter of bushing holes 50 is sized to accommodate a loose and freely rotatable relationship with the clevis pin 52. As will be described below, clevis pin 52 may serve as modality of linking the clamp base 16 and the clamp brace 18, the bushing hole 50 within which the clevis pin 52 is received may also be referred to as a link hole. However, with the use of elastic material, some degree of frictional retention of the clevis pin 52 is possible. Those having ordinary skill in the art will readily appreciate the material selection and dimensioning of the clevis pin 52 and the bushing holes 50 to achieve a satisfactory balance between retention and free movement.

As will be described below, clevis pin 52 may serve as modality of linking the clamp base 16 and the clamp brace 18, the bushing hole 50 within which the clevis pin 52 is received may also be referred to as a link hole. Along these lines, the clevis pin 52 may be referred to as a link pin. The clevis pin 52 defines a central cross bore 54 that is receptive to a clevis tang bolt 56, also referred to as a connecting bolt. In the illustrated embodiment, the central cross bore 54 is threaded Likewise, the clevis tang bolt 56 is threaded for engagement with the threading of the central cross bore 54 of the clevis pin 52. The clevis tang bolt 56 at least partially passes through the space between the first clevis prong 48a and the second clevis prong 48b when coupled to the clevis pin 52. Accordingly, the separation between the clevis prongs 48a, 48b are to such an extent as to allow the clevis tang bolt 56 to freely pass therebetween without any resistance from the inner walls thereof. The combined defined thickness of the clevis prongs 48 and the separation of the first clevis prong 48a and the second clevis prong 48b may correspond to that of the body of the clamp base 16. An exemplary embodiment of the clevis tang bolt 56 is defined by a threaded body section 58, an unthreaded body section 60, and a bolt head 62. In addition to being threaded into the clevis pin 52, the clevis tang bolt 56 is in compressive engagement with the clamp brace 18.

More particularly, the left side 22b of the clamp brace 18 defines a clevis tang engagement slot 64 through which the clevis tang bolt 56 extends. In this regard, like the space between the clevis prongs 48a, 48b of the clamp base 16, the clevis tang engagement slot is sufficiently wide to allow the clevis tang bolt 56 to pass therebetween without any resistance from the inner walls thereof. Because the clevis tang engagement slot 64 has a role in linking the clamp brace 18 to the clamp base 16, it may also be referred to as a link slot. The clevis tang engagement slot 64 further defines a shoulder 66 that contacts and is engaged with the bolt head 62. As illustrated in the exemplary embodiments, the bolt head 62 may have a larger outer diameter than the bolt body. Rather than the bolt head 62 engaging the shoulder 66 directly, a washer 68 may be disposed against the shoulder 66, and the clevis tang bolt 56 being inserted through the washer. By threading the clevis tang bolt 56 through the clevis pin 52, the bolt head 62 is brought closer thereto. That is, the distance between the clamp base 16 and the clamp brace 18 is adjustable based upon the extent of the clevis tang bolt 56 is threaded into the clevis pin 52. This is also understood to exert a compressive force against the washer 68 and the shoulder 66, which in turn compresses the clamp brace 18 against the clamp base 16.

With the use of the above-described selective adjustment modality, a much finer adjustment than selecting one pivot bearing 26 or another is possible. Although FIGS. 4C and 4D depict the distance between the clamp base 16 and the clamp brace 18 set by the adjustment modality on the right side 20 thereof, e.g., the selective insertion of the pivot pin 34 on a statically sized extension arm 28 to one of a first or second pivot bearing 26a, 26b, being the same as the adjustment modality on the left side 22 thereof, e.g., the threaded engagement of the clevis tang bolt 56 to the clevis pin 52, this is by way of example only and not of limitation. The clevis tang bolt 56 may be threaded into the central cross bore 54 of the clevis pin 52 to a greater extent, thus compressing the left side 22 of the clamp base 16 and clamp brace 18 further. Alternatively, the clevis tang bolt 56 may be withdrawn from the central cross bore 54 to a greater extent, thus expanding the left side 22 of the clamp base 16 and clamp brace 18. This may result in the clamp brace 18 being pivoted slightly because of the axis of the clevis tang bolt 56 being out of alignment with the straight vertical axis of the central cross bore 54 in an otherwise equidistant setting of the left and right sides 20, 22. The clevis pin 52 has a cylindrical shape and thus rotates within the bushing holes 50, accommodating the pivoting of the clamp brace 18 relative to the clamp base 16 while maintaining the rigid perpendicular relationship between the clevis tang bolt 56 and the clevis pin 52.

Between the right sides 20 and the left sides 22, both the clamp base 16 and the clamp brace 18 define a respective arcuate jaw 70. Specifically, the clamp base 16 defines an arcuate jaw 70a, while the clamp brace 18 defines an arcuate jaw 70b. Various embodiments of the present disclosure further contemplate a pair of inserts 72a, 72b each engaged to a respective one of the arcuate jaws 70a, 70b of the clamp base 16 and the clamp brace 18. FIG. 3 best illustrates the profile of the inserts 72, which are defined by a convex outer profile 74 that corresponds to the concave arcuate jaw 70, as well as a concave inner profile 76. In view of the jaw/clamping function of the clamp base 16 and the clamp brace 18 being a central feature, such components may also be referred to herein as a first jaw and a second jaw, respectively.

The outer profile 74 and the inner profile 76 are understood to be differently shaped, as the specific size and shape of the concave inner profile 76 may be varied in accordance with the structure 12 to which it is intended to be engaged. Multiple inserts 72 may be provided so that the user can select one that most closely matches the size and shape of the structure 12. The selection of a particularly sized insert 72 is understood to be another adjustment selective adjustment modality of the mounting device 10. Across such multiple arcuate inserts 72, the profile of the arcuate jaws 70 is unchanged, so the outer profile 74 of the inserts 72 likewise remains consistent for interchangeability. As shown in the example embodiment of FIG. 3, the arcuate jaws 70 ma have a more elliptic or flat shape, with the inner profile 76 of the inserts 72 having a more circular shape. FIG. 4D illustrates an application that involves extending the spacing between the clamp base 16 and the clamp brace 18 to its maximum by utilizing the aforementioned spacing adjustment modalities. With a larger structure 12, the side portions of the inserts 72 can be compressed to conform to a larger perimeter arc segment of the structure. On the other hand, FIG. 4C illustrates reducing the spacing between the clamp base 16 and the clamp brace 18 to conform to a structure 12 with a smaller perimeter. Thus, narrower size increments in the size of the structure 12 can be accommodated with a single insert 72, with fuller and more even engagement over the entire surface area thereof. The inserts 72 are understood to be constructed of an elastomeric material, and further, one that has a coefficient of friction greater than 0.075 when placed against a metal surface such as aluminum or steel that is a typical material of the structure 12.

As noted above, user-interchangeability of the inserts 72 is contemplated. However, a secure retention of the inserts 72 to the arcuate jaws 70 beyond a frictional engagement along the outer profile 74 is also envisioned. In this regard, the inserts 72 define a series of spaced ribs 78 along the outer profile 74. The ribs 78 are understood to extend the entire thickness of the insert 72, and have a roundly tapered profile. The arcuate jaws also define a corresponding set of spaced grooves 80 that extend the entire thickness of the body of the clamp base 16/clamp brace 18. The grooves 80 have a u-shaped profile receptive to the roundly tapered ribs 78 of the insert 72. The co-engagement of the grooves 80 and the ribs 78 is contemplated to limit the rotational shifting of the insert 72 relative to the arcuate jaw 70. Furthermore, with the increased surface area contact between the insert 72 and the respective arcuate jaw 70, the tendency for the insert 72 to slide off perpendicularly is also reduced.

The aforementioned clamp configuration may be utilized as a base mount for securing a variety of apparatuses to the structure 12. Briefly discussed above was a first variation 14a of the secondary mount that is a part of the clamp base 16. In further detail, the clamp base 16 defines a mounting platform 82 that can incorporate a variety of secondary mounts 14. The embodiment as further detailed in FIGS. 2 and 3 include a joint collet 84 that is defined by a threaded collar structure 86 that is separated into multiple segments 88 by a set of spaced slots 90. The top end of the collar structure 86 defines a taper 92, while the interior of the collar structure 86 is understood to be partially spherical to receptively engage a ball joint 94. A collet nut 96 is threaded on to the collar structure 86, compressing the segments 88 of the collar structure 86 around the ball joint 94. In a partially threaded state, the ball joint 94 may freely move within the socket defined by the collar structure, though when tightened, such free movement may be restricted by the compressive force of the interior of the collar structure 86 against the ball joint 94.

Extending from the ball joint 94 is a stalk 97 that is attached to a magnetic head 98. Within the body of the magnetic head 98 are a series of spaced magnets that are covered by an elastomeric material. The magnets are understood to engage with a ferromagnetic plate that is fixed to a mobile device. The device cradle implemented with the magnetic head 98 is presented by way of example only and not of limitation. Any other suitable device cradle may also be utilized, such as conventional frictional retention mobile device cradles and the like.

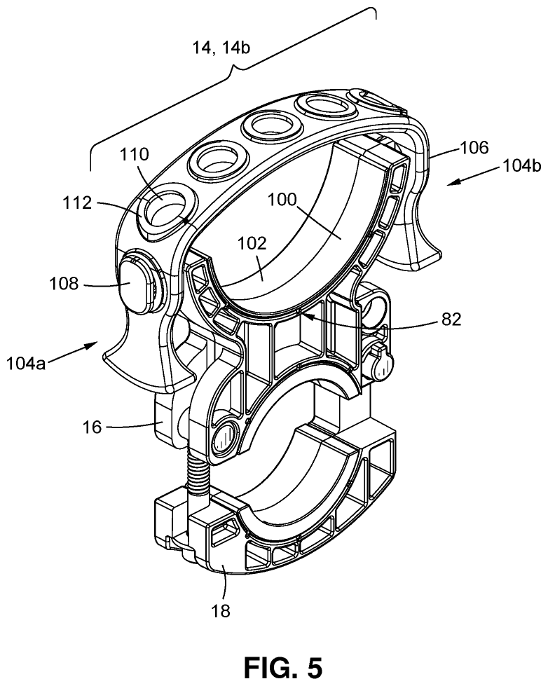

Beyond device cradles, other apparatuses may be mounted to the structure utilizing the mounting device 10 disclosed herein as the base mount. FIG. 5 illustrates such an alternative configuration for a secondary mount 14b. Instead of the joint collet 84 described above in relation to the first variation of the secondary mount 14a, the mounting platform 82 is an arcuate bracket 100 to which a cylindrical article such as a fire extinguisher or portable loudspeaker device may be mounted. Similar to the arcuate jaws 70 of the base mount, there may be an elastomeric insert 102 with a plurality of ribs that are engageable to corresponding slots defined by the bracket 100.

In further detail, the bracket 100 is defined by a right side end 104a and an opposed left side end 104b, and the second variation of the secondary mount 14b further includes a retention strap 106 that extends from the right side end 104a to the left side end 104b. At each of the right side end 104a and the left side end 104b there is a respective strap coupling 108, which in the illustrated embodiment, is a flat projection extending outwardly from the side end 104. The retention strap 106 defines one or more mounting slots 110 that may be coupled to the strap coupling 108.

It is contemplated that the retention strap 106 is constructed of an elastomeric material that stretches over and contacts the cylindrical article, exerting a compression force against the same. The opening of the mounting slots 110 may thus be manually expanded to fit the same over the platform of the strap coupling 106. Furthermore, mounting slots 110 may each include a collar 112 that provides increased rigidity and structural integrity to the mounting slots 110 for better retention characteristics when fitted over the strap coupling 108. As shown in the exemplary embodiment, there are multiple mounting slots 110 at successive length increments of the retention strap 106, which allow for the selective coupling thereof to either one of the strap couplings 108 with varying lengths of the retention strap 106 extending between the right side end 104a and the left side end 104b. The foregoing illustration of the secondary mount 14b is presented for exemplary purposes only, and those having ordinary skill in the art will recognize a multitude of different implementations for a bracket and strap structure to retain cylindrical articles.

The particulars shown herein are by way of example and for purposes of illustrative discussion of the embodiments of the accessory mounting device only and are presented in the cause of providing what is believed to be the most useful and readily understood description of the principles and conceptual aspects thereof. In this regard, no attempt is made to show more details than is necessary for a fundamental understanding of the disclosure, the description taken with the drawings making apparent to those skilled in the art how the several forms of the presently disclosed accessory mounting bracket may be embodied in practice.

What is claimed is:

1. A mounting device, comprising:
a clamp base with a jaw coupling platform defining a first pivot bearing and a second pivot bearing, a clevis with a pair of clevis prongs each defining a bushing hole, a mounting platform, and an arcuate jaw;
a clamp brace including an extension arm with a pivot pin engageable with either one of the first pivot bearing and the second pivot bearing of the clamp base, the clamp brace defining a clevis tang engagement slot and an arcuate jaw;
a clevis pin defining a central cross bore and being received within the bushing holes of the pair of clevis prongs;
a clevis tang bolt engageable with the clevis pin and received within the clevis pin engagement slot of the clamp brace; and
a pair of arcuate inserts each engaged to a respective one of the arcuate jaws of the clamp base and the clamp brace.

2. The mounting device of claim 1, wherein:
the tang bolt is defined by a bolt body and a bolt head with a wider diameter than the bolt body; and
the clevis tang engagement slot defines a shoulder engageable to the bolt head of the tang bolt.

3. The mounting device of claim 2, wherein the bolt body of the clevis tang bolt and the central cross bore of the clevis pin are threaded and are in threaded engagement with each other.

4. The mounting device of claim 3, wherein a distance between the clamp base and the clamp brace is adjustable based upon the extent of the clevis tang bolt being threaded into the central cross bore of the clevis pin.

5. The mounting device of claim 1, wherein the pivot pin is keyed in correspondence with a slot defined in each of the first pivot bearing and the second pivot bearing of the clamp base.

6. The mounting device of claim 1, wherein:
the semi arcuate jaws of the clamp base and the clamp brace each define a plurality of spaced grooves;
each of the pair of arcuate inserts define a plurality of spaced ribs; and
the spaced grooves of the arcuate jaws of the clamp base and clamp brace are engageable to the corresponding ones of the plurality of spaced ribs of the respective one of the pair of arcuate inserts.

7. The mounting device of claim 1, wherein each of the pair of arcuate inserts is defined by an outer profile and an inner profile.

8. The mounting device of claim 7, wherein the outer profile is shaped differently from the inner profile.

9. The mounting device of claim 1, wherein the pair of arcuate inserts are constructed of an elastomeric material.

10. The mounting device of claim 1, further comprising:
a joint collet extending from the mounting platform and receptive to a ball joint; and
a nut engageable to the joint collet.

11. The mounting device of claim 10, wherein the ball joint includes a stalk connected to a user device mount.

12. The mounting device of claim 11, wherein the user device mount is a magnetic head engageable to a plate fixed to a user device.

13. The mounting device of claim 1, further comprising:
an elastic retention strap defining a plurality of mounting slots;
wherein the mounting platform defies an arcuate jaw section and a pair of opposed strap couplings engageable to one of the mounting slots of the elastic retention strap.

14. A clamp mount comprising:
a first jaw defined by a first side with a first pivot hole and a second pivot hole offset from the first pivot hole, and an opposed second side defining a link hole;
a second jaw defined by a first side with an arm including a pivot pin rotatably engageable with a selected one of the first hole and the second pivot hole of the first jaw, and an opposed second side defining a link slot;
a link pin engaged to the link hole;
a connecting bolt extending through the link slot of the second side of the second jaw and engaged thereto, and connected to the link pin; and
elastomeric jaw inserts fixed to the first jaw and the second jaw.

15. The clamp mount of claim 14, wherein the first jaw includes a socket receptive to a ball at least partially rotatable within the socket, the ball including a stalk extending therefrom and attached to a device cradle.

16. The clamp mount of claim 15, wherein the device cradle is a magnetic head.

17. The clamp mount of claim 14, wherein the first jaw includes an attachment bracket and opposed band couplings at respective ends of the attachment brace.

18. The clamp mount of claim 17, further comprising a mounting strap having a first end attachable to one of the strap couplings and a second end attachable to another one of the strap couplings.

19. The clamp mount of claim 14, wherein the link pin defines a threaded cross bore and the connecting bolt is threaded for engagement with threading of the cross bore.

20. The clamp mount of claim 14, wherein the pivot pin is keyed in correspondence with a slot defined in each of the first pivot hole and the second pivot hole of the first jaw.
